(19) United States
(12) Patent Application Publication
(10) Pub. No.: US 2014/0199020 A1
(43) Pub. Date: Jul. 17, 2014

(54) SYSTEM FOR TRANSMITTING OPTICAL SIGNALS

(71) Applicants: Thomas Nappez, Valence (FR); Philippe Rondeau, Allex (FR); Jean-Pierre Schlotterbeck, Rochefort-Samson (FR); Elise Ghibaudo, Grenoble (FR); Jean-Emmanuel Broquin, Grenoble (FR)

(72) Inventors: Thomas Nappez, Valence (FR); Philippe Rondeau, Allex (FR); Jean-Pierre Schlotterbeck, Rochefort-Samson (FR); Elise Ghibaudo, Grenoble (FR); Jean-Emmanuel Broquin, Grenoble (FR)

(73) Assignee: THALES, Neuilly Sur-Seine (FR)

(21) Appl. No.: 14/007,087

(22) PCT Filed: Mar. 9, 2012
(86) PCT No.: PCT/EP2012/054167

§ 371 Date: Mar. 17, 2014

(30) Foreign Application Priority Data
Mar. 31, 2011 (FR) 1100956

(51) Int. Cl. H01S 3/00

(52) U.S. Cl. CPC H01S 3/005
USPC 385/14

(57) ABSTRACT

Optical signal emission system comprising a passive optical chip (6) and a laser diode (2) disposed at the boundary of said passive optical chip (6), said passive optical chip (6) being furnished with a reflecting structure (5) in upper surface, of a waveguide (7) in upper surface, passing through said passive optical chip (6), linked to the output of said laser diode (2) and passing through said reflecting structure (5), and of an active or non-linear thin layer portion (8) powered by said laser diode (2), covering a part of said waveguide (7), between said laser diode (2) and said reflecting structure (5).

### BACKGROUND OF THE INVENTION

The present invention relates to an optical signal emission system. The continual increase in the transmission capacity requirements of optical telecommunications systems has led to the design of ever more complex devices. Wavelength multiplexing associated with wide-band optical amplification have made possible to obtain bitrates exceeding a terabit per second. High-coherence calibrated laser sources are thus necessary in order to increase information density. The specifications of these sources, produced according to various technologies, are to be compact and integrated, mono-mode and mono-frequency, with low noise and good thermal and mechanic stabilities.

Semi-conductor lasers, on account of their high gain and their compactness, are particularly suited. The design of both vertical size of the heterojunction and horizontal size of electrical contact ensures single-mode emission while the use of adapted resonators ensures single-frequency behavior. However, these components are very sensitive to the various reflections that can occur along the transmission line. Optical feedback within the laser disturbs the latter and greatly increases its relative intensity noise. A conventional solution, such as illustrated in FIG. 1, is to place an optical isolator 1 after the output facet of a laser diode 2 ensuring a preferred direction of travel of the optical signal on the transmission line 3 so as to avoid any feedback of light within the laser cavity. A study validating these components for telecoms applications has been carried out by K. Petermann et al. in ‘Noise distortion characteristics of semiconductor lasers in optical fiber communication systems’, IEEE J. Quant. Electron., Vol. 18, p. 543, 1982.

Another weak point of such architecture is its sensitivity to temperature variations. The high thermal expansion coefficient of semi-conductors makes it necessary to add temperature stabilization system for most applications. It can take the form of a fluid passing in proximity to the active zone as in American patent U.S. Pat. No. 5,903,583 or take the form of a Peltier module stabilizing the temperature according to a determined setpoint, as proposed in American patent U.S. Pat. No. 6,826,916. This stabilization systems require a mechanical support and an electrical power supply. This reduces the integration and greatly increases the cost of the device.

A solution is to use for the laser emission an active material with a lower thermal expansion coefficient than that of the materials used for laser diodes, i.e. ternary or quaternary alloys of semi-conductors. A material is termed active when it makes it possible to modify either the wavelength of a signal (e.g. laser effect, frequency doubling), or to increase the amplitude of a signal (e.g. amplifier). In contrast, a passive material merely guides the light (in a rectilinear manner or while rotating it) or filters it (spatial, spectral or modal filter).

Glass is the most suitable material. Indeed, its thermal expansion coefficient is about eight times lower than those of semi-conductors while being a low optical loss material for integrated optics. Fibered and planar glass architectures are known. S. A. Babin et al. in ‘Single frequency single polarization DFB fiber laser’, Laser Phys. Lett., Vol. 4, p. 428, 2007, undertake the experimental demonstration of a fibered DFB laser, DFB standing for “Distributed FeedBack”, is a laser for which a part of the active region is in interaction with a periodically structure which ensure single frequency emission, such as a Bragg grating with a phase shift. This grating creates the optical resonator of the laser, ensuring single-mode and stable mono-frequency emission. J. Zhang et al. in ‘Stable single-mode compound-ring erbium-doped fiber laser’, J. Light. Techn., Vol. 14, p. 104, 1996, use an entirely fibered double cavity. Each having their own inherent resonance, the compound cavities allow mono-frequency emission thanks to the Vernier effect. Concerning planar integrated optics, S. Blaize et al. in ‘Multiwavelength DFB waveguide laser arrays in Yb-Er codoped phosphate glass substrate’, Phot. Techn. Lett., Vol. 15, p. 516, 2003, have made DFB lasers in an active glass substrate exhibiting the desired spectral emission characteristics for telecommunications.

However, both architectures, fibered and planar, suffer from a lack of compactness. The power supply required for the operation of the active medium requires additional coupling devices. Indeed, this power is usually generated by a so-called pump laser diode. It is then necessary to inject this power into the active medium. This involves the use of volume optics or of lensed waveguides to reduce the heavy losses by coupling between the laser diode and the waveguide on glass. Volume optics are the elements acting on the light which are not integrated on a chip or cemented at the tip of optical fibers; they therefore involve propagation of light in free space over non-negligible distances. A lensed waveguide is a waveguide whose at least one of its facets is modified so as to reduce coupling losses and the input and output of the guide. This relates to a great majority of the optical fibers whose ends can be polished or etched according to a given geometry. Laser diodes have an step-index, i.e. a large difference between the refractive index of the substrate and of the core of the guide. The optical field is therefore strongly divergent, in contradiction to glass technologies, where the index contrast is lower. The coupling is also reduced on account of the astigmatism of the laser diode. Their alignment is complex, the stability to vibrations is poor since the components do not form a monolithic block. Moreover, the separation of the pump wavelength from that of the signal at the output of the laser requires a further component, made from a passive material, different from that of the active medium.

A better solution can consist in combining the high-efficiency optical emission of a laser diode with the thermal stability inherent to glass. The principle is to create a resonator external to a laser diode. The wavelength-selective, external feedback can indeed lock and stabilise the laser diode's emission. C. A. Park et al. in “Single-mode behaviour of a multimode 1.55 μm laser with a fibre grating external cavity’, Electron. Lett., Vol. 22, p. 1132, 1986, use an optical fiber comprising a Bragg grating to lock the laser diode's emission. They thus obtain stable mono-frequency emission between 20° C. and 50° C. without active temperature stabilization. The optical coupling between the laser diode and the fiber is undertaken by virtue of volume optics. A more compact, planar device has been proposed by T. Tanaka et al. in ‘Integrated external cavity laser composed of spot-size converter LD and UV written grating in silica waveguide on Si’, Electron. Lett., Vol. 32, p. 1202, 1996. It comprises a planar device for coupling between the diode and the planar guide followed by a Bragg grating, both integrated on an optical chip. No volume optics for coupling the field of the laser diode in the waveguide is thus used. However, these robust components suffer, just like their fibered equivalents, from the loss of power available at the output of the device. Indeed, to lock the laser diode, the external feedback must be sufficiently strong to overcome both the initial cavity losses and the losses caused in the external cavity. This therefore allows only a small portion of the signal to escape and it is made difficult to obtain high power.

The power can, for example, be increased by using a broad stripe laser diode. The on-glass optical chip then comprises a broad zone, placed at the tip of the laser diode, followed by a narrow part. An adiabatic transition links them. The external cavity is closed partially by virtue of an integrated reflecting structure on the narrow part. This feedback then locks the emission of the laser diode on the modes supported by the narrow part. The feedback modifies the modal emission of the diode rather than its spectral emission. Nonetheless, the problem of the loss of useful power at output, caused by the strong external feedback, remains to be solved. Anti-reflection treatments on the output facet of the laser diode can then be used to open the cavity of the laser diode and therefore to lock it more easily. However, the cost of anti-reflection treated laser diodes is very high.

### SUMMARY OF THE INVENTION

An aim of the invention is to be able to use the whole of the power present in the external cavity without anti-reflection treatment such as mentioned herein above.

Another aim of the invention is to produce a laser diode's planar external cavity and to monolithically integrate active elements therein.

Another aim of the invention is to obtain single-mode and single-frequency emission by virtue of an entirely planar interfaced device.

Another aim of the invention is to create a monolithic laser module without optical fibers or volume optics.

Another aim of the invention is to create a monolithic optical amplification module without optical fibers or volume optics.

It is proposed, according to one aspect of the invention, an optical signal emission system comprising a passive optical chip and a laser diode disposed at the boundary of said passive optical chip, said passive optical chip being furnished with a reflecting structure as upper surface, and with a waveguide as upper surface, passing through said passive optical chip, linked to the output of said laser diode and passing through said reflecting structure. The passive optical chip is, furthermore, furnished with an active or non-linear thin layer portion powered by said laser diode, covering a part of said waveguide, between said laser diode and said reflecting structure.

Such an optical signal emission system makes it possible to use the majority of the power present in the external cavity without expensive anti-reflection treatment of the laser diode, to produce a planar external cavity in respect of a laser diode and to monolithically integrate active elements therein, all at reduced cost.

In one embodiment, said system comprises, furthermore, a signal separator adapted for separating the residual pump wave of said laser diode from the signal of the waveguide at the output of said thin layer portion.

Thus, the signal is separated directly from the residual pump at the output of the device.

According to one embodiment, said separator comprises an adiabatic-coupling duplexer, a Mach-Zehnder interferometer, a multi-mode interferometer or a leakage device.

In one embodiment, said laser diode is of broad stripe type, and the waveguide portion situated between said laser diode and the thin layer portion comprises a taper.

A taper is defined as a part being an adiabatic transition between a wide input of the waveguide disposed at the output of the laser diode and a narrow portion of the waveguide.

Thus, the pump power is, at reduced cost, greatly increased. For example, said taper can be, at least piecewise, defined by linear, hyperbolic, parabolic, exponential, polynomial, sinusoidal functions, or as a circular arc. The size of the device can therefore be reduced.

According to one embodiment, said thin layer portion comprises an optical amplifier and/or a DFB or DBR laser, and/or a nonlinear crystal, and/or a polymer.

Thus, the thin layer portion uses the whole of the available pump power, and the possible hybridization of various materials offers great versatility of applications.

For example, when said thin layer portion comprises an optical amplifier, said system can comprise, furthermore, a pump/signal mixer forming a junction between said waveguide at the input of said thin layer portion, and an extra waveguide for an input signal, to receive as input the signal to be amplified.

For example, said mixer can comprise an adiabatic-coupling duplexer, a Mach-Zehnder interferometer, a multi-mode interferometer or a leakage device.

For example, said reflecting structure comprises a Bragg grating, a photonic crystal, or a planar feedback device.

### BRIEF DESCRIPTION OF THE DRAWINGS

The invention will be better understood on studying a few embodiments described by way of wholly non-limiting examples illustrated by the appended drawings in which:

FIG. 1 schematically illustrates a known embodiment for preventing the reflections that may be caused along the transmission line; and

FIGS. 2, 3, 4 and 5 illustrate optical signal emission systems, according to aspects of the invention.

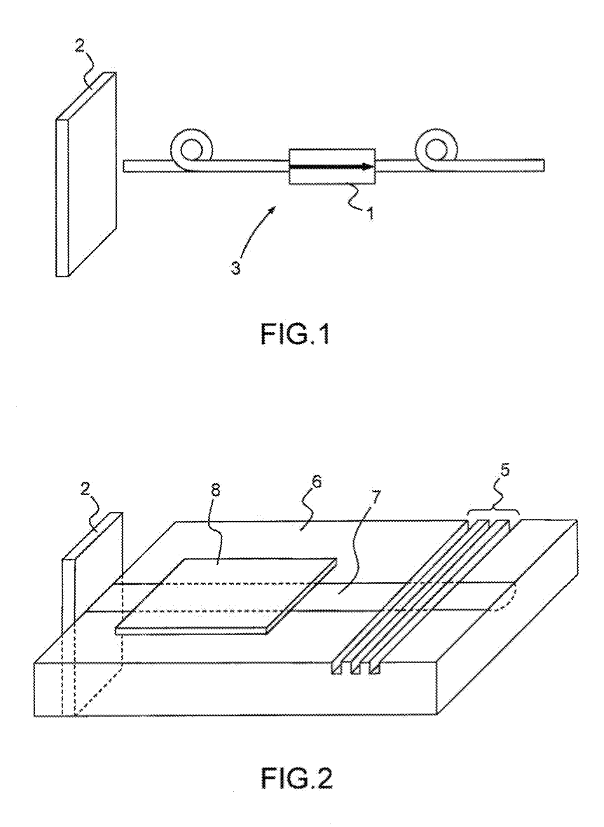

### DETAILED DESCRIPTION

In all the figures, the elements having the same references are similar.

Such as illustrated in FIGS. 2 to 5, an optical signal emission system according to one aspect of the invention comprises a laser diode 2 which is not used as signal emission source but as pump, or, stated otherwise, as source of energy supplied to the integrated active medium inside the external cavity. The difference in wavelength between the pump and the signal allows a reflecting structure 5 to act only on the pump. It does not then cause any losses for the signal.

In FIG. 2, the optical signal emission system comprises a passive optical chip 6 and a laser diode 2 disposed at the boundary of the passive optical chip 6. The passive optical chip 6 is furnished with a reflecting structure 5 as upper surface, and with a waveguide 7 as upper surface, passing through said passive optical chip 6, linked to the output of said laser diode 2 and passing through said reflecting structure 5. The passive optical chip 6 also comprises an active or non-linear thin layer portion 8 powered by the laser diode 2, covering a part of said waveguide 7, between the laser diode 2 and the reflecting structure 5.

The signal emission system comprises two optical chips 2 and 6 cemented at the tip. The first chip is a semi-conductor laser 2 whose rear face has undergone a high-reflectivity treatment while the front face may or may not have been anti-reflection treated. The second passive optical chip 6, whose input and output faces may or may not have been polished with an angle, and the active thin layer 8 is monolithically integrated on the upper face. It therefore constitutes a hybrid system, comprising at one and the same time passive elements and active elements.

The optical power of the laser diode 2 coupled in the waveguide 7 supplies the energy necessary for the operation of the active component 8. The active zone is delimited by the spatial extent of the waveguide 7 portion covered by the active thin layer 8. The latter can be assembled on the substrate 6 by wafer bonding or by any technique for depositing or growing thin layers. The waveguide 7 is present under the active thin layer 8 transferred onto the so-called hybrid system or assembly.

The thin layer 8 formation above the passive waveguide 7 makes it possible to obtain a hybrid mode propagation, in which the light is situated at one and the same time in the passive and active media. The thin layer portion 8, monolithically integrated into the passive chip 6, is linked to the laser diode 2 by virtue of the dedicated coupling guide 7. The system is dimensioned so as to obtain high coupling efficiencies, at one and the same time with the laser diode 2 and with the hybrid guide formed by the portion of the guide 7 situated below the thin layer 8. The various portions of the waveguide 7 are produced according to the same and unique technological method, thereby dispensing with the problems of alignment and greatly reducing the fabrication costs. The longer the portion of the waveguide 7 is in interaction with the reflecting structure 5, the greater the reflection at the output of the hybrid guide is. The reflecting structure 5 is designed to reflect the wavelength of the laser diode 2 while allowing the signal emitted by the active or non-linear thin layer portion 8 to escape. The reflecting structure 5 closes the cavity external to the laser diode 2.

Another advantage of the reflecting structure 5 is to recycle the pump power not used by the active or non-linear zone 8.

The active or non-linear thin layer portion 8 can comprise a Bragg grating, interacting with the power guided in the waveguide 7 part covered by the active or non-linear thin layer portion 8. A DFB laser can thus be created within the cavity external to the laser diode 2. In the case where the target application relates to single-mode laser emission, the waveguide 7 portions situated between the laser diode 2 and the output of the active or non-linear thin layer portion 8 are single-mode at the wavelength of the signal.

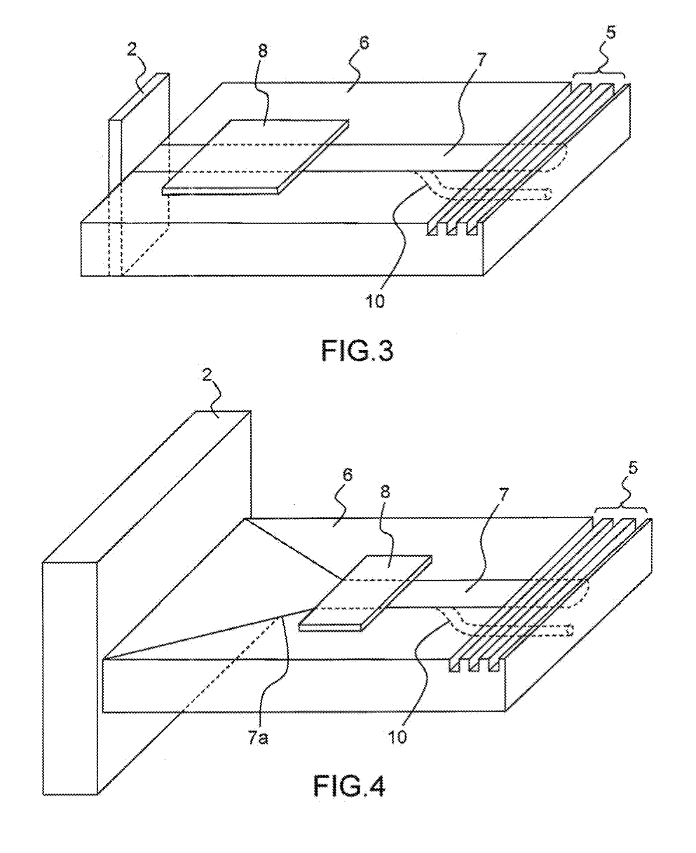

In this regard, FIG. 3 illustrates a variant in which the optical signal emission system also comprises the integration of a separation component 10 adapted for separating the pump wave of the laser diode 2 from the signal of the waveguide 7 at the output of the thin layer portion 8. The separation component 10 is a passive component which allows to separate two wavelengths. It comprises an input waveguide portion 7 and two output waveguides, the output of the waveguide 7 and the output part of the secondary waveguide 10. The portion of the waveguide 7 at the output of the thin layer portion 8 is the input portion of the separator 10. It contains the residual pump and the signal. The output waveguides are the part of the output waveguide 7 which now contains only the pump signal and the output waveguide portion 10, which carries the signal at the output of the hybrid laser consisting of the active or non-linear thin layer portion 8 and the guide 7 portion situated below the thin layer.

In FIG. 3, an example of a vertically integrated adiabatic-coupling duplexer can be that developed by L. ONESTAS et al. in ‘980 nm-1550 nm vertically integrated duplexer for hybrid erbium-doped waveguide amplifiers on glass’, Proc. Of SPIE, Vol. 7218-05, 2009. The output waveguide of the passive chip 6 is therefore the secondary guide or separator 10 which collects the signal without the pump. The latter, propagating in the portion of the waveguide 7 at the output of the thin layer portion 8, is reflected by the reflecting structure 5 and stabilizes the laser diode 2. The separator component 10 can be an adiabatic-coupling duplexer, such as an asymmetric Y junction, a multi-mode interferometer, a Mach-Zehnder interferometer, a leakage device, or any other device exhibiting good isolation between the two wavelengths.

An alternative architecture, represented in FIG. 4, makes it possible to use a broad stripe laser diode 2 as energy source for the DFB laser. This makes it possible to obtain a much more significant pump power. The drawback of these stripes is a broad and multi-mode beam in the horizontal direction, incompatible with the form of the signal within single-mode integrated lasers. In this case, the coupling portion 7a of the waveguide 7 then takes the form of a taper. A tpaer is a waveguide whose width varies along its axis. This is a modal filter in the transverse direction: going from a wide and multimode structure to a narrow structure suited to the hybrid guide. The width of the tpaer 7a goes in the course of propagation from the size of the stripe of the laser diode 2 to the dimension of the waveguide 7 of the laser. It thus ensures a role of filtering of the undesired modes. Only the necessary mode or modes are guided within the portion of the waveguide 7 covered by the thin layer portion 8, thereby ensuring optimal use of the pump wave. The form of the taper can, for example, be defined entirely or piecewise, by a linear, hyperbolic, parabolic, exponential or polynomial function, in such a way as to minimize its length. A winding of the portion of the waveguide 7 covered by the thin layer portion 8 can be envisaged so as to increase the compactness of the system. To avoid losses on the modes of higher orders within the taper 7a, the reflecting structure 5, traversed by a portion of the waveguide 7, ensures feedback on the modes of the guide 7 solely within the broad stripe laser diode 2. If the resonator is defined mainly by this reflection and by the rear facet of the laser diode 2, the modes filtered by the taper 7a undergo too many losses to be able to exceed the laser threshold. The laser diode 2 fed back therefore operates only on the modes supported by the guide 7, avoiding all losses of function within the coupling guide 7a. The feedback 5 can be achieved by a Bragg grating, as shown diagrammatically in FIGS. 2, 3, 4 and 5, by a photonic crystal, or any other structure allowing optical feedback. The integrated separator 10 ensures the separation of the pump from the signal, which can be collected in the output waveguide 10.

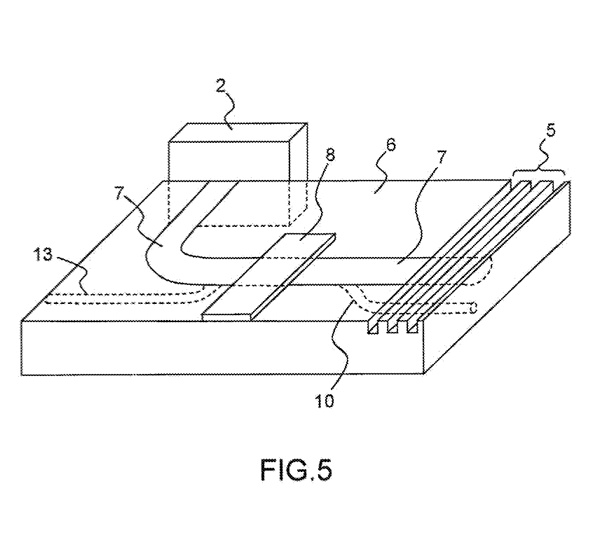

FIG. 5 gives an example of another envisaged application to the use of a thin layer portion 8 as amplifier, i.e. an active material, within a cavity external to a laser diode 2. It relates to an optical amplifier entirely interfaced in planar integrated optics. The pump power is produced by a laser diode 2 and conveyed to the amplifier, formed by the thin layer portion 8 and the portion of the waveguide 7 that it covers, by virtue of the waveguide 7. An additional waveguide 13 for an input signal and the output 10 of the signal are linked to the amplifier by virtue of two duplexers: one 13 combining the signal and the pump at input, the other 10 separating them at output. The active or non-linear thin layer portion 8 transferred onto the passive chip 6 forms a hybrid guidance (formed by the thin layer portion 8 and the portion of the waveguide 7 that it covers) in which the amplification of the arriving signal by the waveguide 13 takes place. This device is particularly adapted for the whole-optical repeaters in telecommunications. Optical fibers are then placed at the tip of the waveguides 13 and 10. The portion of the waveguide 7 covered by the thin layer portion 8 can be wound around itself so as to increase the length of the amplifier without losing compactness.

1. An optical signal emission system comprising a passive optical chip and a laser diode disposed at the boundary of said passive optical chip, said passive optical chip being furnished with a reflecting structure as upper surface, with a waveguide as upper surface, passing through said passive optical chip linked to the output of said laser diode and passing through said reflecting structure and with an active or non-linear thin layer portion powered by said laser diode, covering a part of said waveguide between said laser diode and said reflecting structure.

2. The system as claimed in claim 1, comprising, furthermore, a signals separator adapted for separating the residual pump wave of said laser diode from the signal of the waveguide on output from said thin layer portion.

3. The system as claimed in claim 2, in which said separator comprises an adiabatic-coupling duplexer, a Mach-Zehnder interferometer, or a leakage device.

4. The system as claimed in claim 1, in which said laser diode is of broad stripe type, and the waveguide portion situated between said laser diode and the thin layer portion comprises a taper.

5. The system as claimed in claim 4, in which said taper is, at least piecewise, defined by linear, hyperbolic, parabolic, exponential, polynomial, sinusoidal functions, or as a circular arc.

6. The system as claimed in claim 1, in which said thin layer portion comprises an optical amplifier and/or a DFB or DBR laser, and/or a nonlinear crystal, and/or a polymer.

7. The system as claimed in claim 6, in which, said thin layer portion comprising an optical amplifier, said system comprises, furthermore, a pump/signal mixer forming a junction between said waveguide at input of said thin layer portion, and an extra waveguide for an input signal, to receive as input the signal to be amplified.

8. The system as claimed in claim 7, in which said mixer comprises an adiabatic-coupling duplexer, a Mach-Zehnder interferometer, a multi-mode interferometer or a leakage device.

9. The system as claimed in claim 1, in which said reflecting structure comprises a Bragg grating, a photonic crystal, or a planar feedback device.
